(19) United States
(12) Patent Application Publication
(10) Pub. No.: US 2009/0308467 A1
(43) Pub. Date: Dec. 17, 2009

(54) Anti-leak water guard

(76) Inventors: Vincent P. Gurubatham, St. Joseph, MI (US); Gilbert R. Gurubatham, Gainsville, VA (US); Reakha P. Janus, Boyds, MD (US); Damayanti Gurubatham, St. Joseph, MI (US)

Correspondence Address: Gilbert R. Gurubatham, 14260 Snickersville Drive, Gainsville, VA, 20155, US

(21) Appl. No.: 12/214,060

(22) Filed: Jun. 16, 2008

(51) Int. Cl. F16L 3/00

(52) U.S. Cl. 137/377

(57) ABSTRACT

A system and a method for preventing a cracked bib from leaking water into a dwelling by redirecting the leaking water out of dwelling.

### BACKGROUND OF THE INVENTION

1. Field of the Invention

This invention relates generally to plumbing fixtures and more particularly to faucets and bibs.

2. Related Art

Often people forget to disconnect their garden hose from the faucet before the freezing temperatures of winter occur. When freezing temperatures occur, the water trapped in the hose and faucet may freeze. This frozen water has the ability to cause the body of the bib to crack and fail. In other instances, the faucet may be installed wrong with a negative slop towards the basement or crawl space preventing the water from draining out when a hose is disconnected. The remaining water may freeze in the bib resulting in the same type of failure. Once a crack has occurred in the bib, water will typically escape into the inside of a dwelling and potentially cause extensive water damage.

In FIG. 1, a diagram 100 of a prior art faucet 102 and bib 104 mounted in a dwelling 106 having a crack 108 located within the dwelling 106 is shown. The actual valve for turning the water on and off may be located near the threaded portion 110 of the bib. Once a crack 108 has formed in the bib 104, water is allowed to escape into the dwelling 106 whenever the handle 112 is turned and valve opened. Even if water does come out of the faucet 102, it will also be escaping into the dwelling 106 and may not be noticed by anyone for some time. Thus, the more water that enters the dwelling 106 the greater the damage may be.

In yet other instances, a foreign substance, such as a small stone may become lodge within the valve and upon using force to turn the faucet on or off the body of bib 102 may be cracked. When water is again turned on, the interior of the dwelling 106experiences water damage.

Therefore, there is a need for an approach to providing water from a cracked bib to be directed out side of a dwelling in order to prevent water damage within the dwelling and provide an external indication of a leaking bib.

### SUMMARY

An anti-leak water guard (AWG) is formed and mounted in an area where a bib is traditionally placed. The anti-leak water guard is able to accept a bib and both the anti-leak water guard and the bib may be fixed trough a dwellings wall. The anti-leak water guard encloses the bib, such that if a leak occurs the water has a path out of the anti-leak water guard and out of the dwelling.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a diagram 100 of a prior art faucet 102 and bib 104 mounted in a dwelling 106 where the bib has a crack 108.

FIG. 2 is a side cut-a-way drawing 200 of the anti-leak water guard (AWG) 202.

FIG. 3 is a drawing 300 of the faucet end 206 of the AWG 202.

FIG. 4 is a drawing 400 of the AWG 202 with a faucet 402 and bib 404 attached to a dwelling 406.

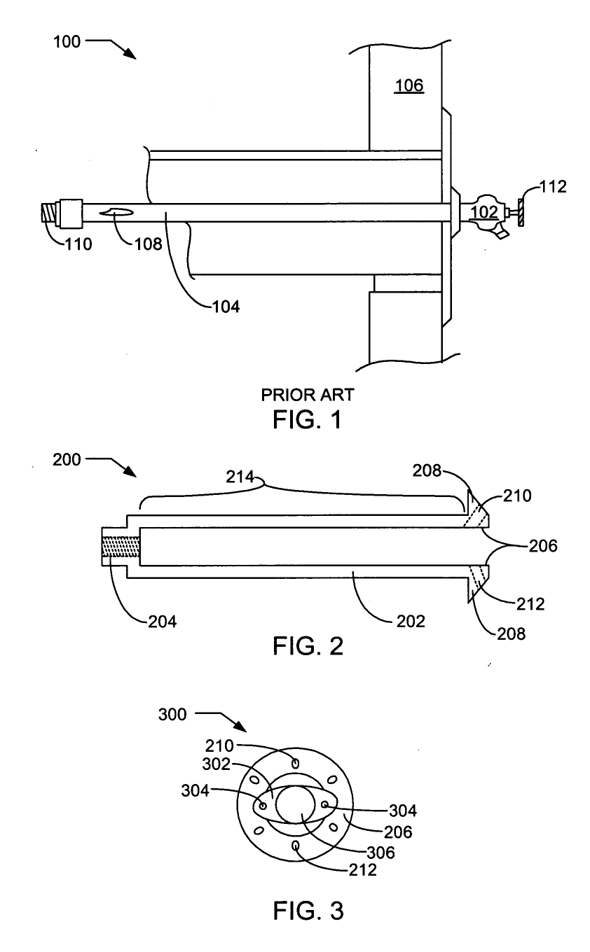

### DETAILED DESCRIPTION

An approach for an anti-leak water guard (AWG) 202 is described. Turning to FIG. 2, a side cut-a-way drawing 200 of the AWG 202 is shown. The AWG 202 may have a threaded end 204 that is able to receive the threads 110 of bib 104. The other end (faucet end 206) of the AWG 202 is able to receive the faucet 102. The faucet end 206 may have one or more extensions 208 that aid in affixing the AWG 202 to the wall of a dwelling. The AWG 202 also may have holes drilled through the faucet end 206, such as holes 210 and 212 that enable water to exit the AWG 202.

The AWG 202 may be formed out of a plastic material, such as Polyvinyl chloride (PVC) plastic with a chemical formula of (CH₂═CHCl) commonly used in plastic plumbing pipes or other types of known plastics. Other materials such as copper, aluminum, iron, or similar materials that may be formed or molded in such a way to accept a bib 104 may also be used to form the AWG 202. The AWG 202 may be molded as a single structure or be made up of multiple pieces that are put together, such as the extensions 208 being formed separate from the body 214. In other implementations, it is conceivable that the bib 104 may pass through the AWG 202 where the AWG forms a seal around the bib 104 without the use of threads in the threaded end 204.

Turning to FIG. 3, a drawing 300 of the faucet end 206 of the AWG 200 is shown. The faucet end 206 may have a reinforced portion 302 formed to accept the faucet 102. Screw holes 304 may be formed in the faucet end 206 of the AWG 202 that line up with screw holes (not shown) in the faucet 102. The water holes 210 and 212 can be seen along with other holes around the faucet end 206. An opening for the bib 104 in the faucet end 306 of the AWG 206 is also shown in FIG. 3. In other implementations, the holes (210, 212 and the other water holes) to allow water to escape may be formed as one or more openings in the faucet end 206 rather than drilled into the faucet end 206. In yet other implementations, both formed and drilled holes may be used.

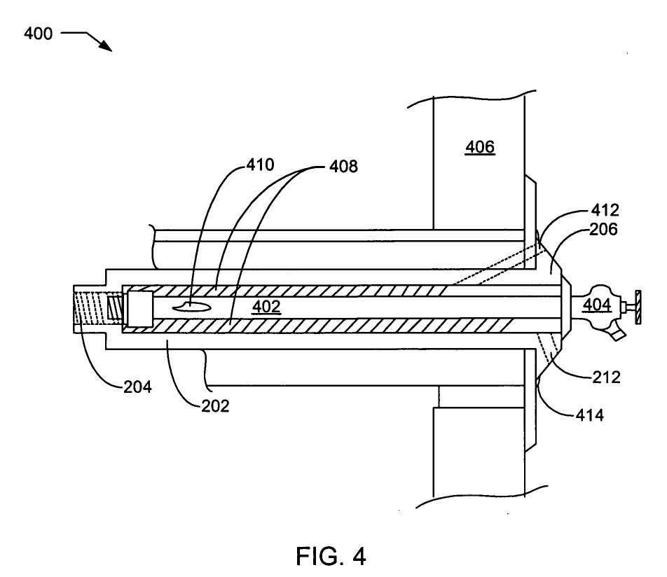

In FIG. 4, a drawing 400 of the AWG 202 with a faucet 402 and bib 404 attached to a dwelling 406 is shown. The faucet end 206 is fixed secure against the side of the dwelling 406 and the faucet 404 is similarly fixed secure against the faucet end 206. The bib 402 extends into the AWG 202 and may be screwed into the threaded end 204 of the AWG 202. The space between the AGW 202 and the bib 402 may be filled with insulation material 408. Examples of insulation material may be open cell foam that would enable water to pass, paper, or other water passable or dissolvable materials. In other implementations, insulations may be placed around the outside of the body 202 around the portion that extends into the dwelling. The insulation 408 may stop before the holes, such as holes 412 and 212. The insulation may be foam, fiberglass, paper, or any other type of materials that would increase thermal “R” value of body 202. In yet other implementations, one or more holes, such as hole 412 may be formed in the body 214 of the AWG 202 to allow water to escape from the AWG 202 if bib 402 fails.

The securing of the faucet end 206 to the dwelling 406 may occur with the use of fasteners, such as screws nails, rivets or other types of fasteners commonly used dwelling fasteners. In other implementations, glue such as LIQUID NAILS™, or MASTIC™ may be used to glue the faucet end 206 to the dwelling 406. Regardless of what type of securing approach is used, the faucet end 206 of the body 202 may be caulked 414 after installation or during installation to form a weather proof seal between the AWG 202 and the dwelling 406.

If a crack should form in bib 402, such as crack 410, the water that escapes from the bib 402 is directed outside of the dwelling via shown holes 412 and 212. The water may pass through or dissolve the insulation 408 in order to exit the AWG 202.

The foregoing description has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention and are not intended to be limited to only the described implementation.

What is claimed is:

1. An anti-leak water guard (AWG) apparatus, comprising:
a body with a faucet end and a valve end;
at least one water hole formed by the valve end; and
a portion of the faucet end adapted to accept a faucet, where the body is able to accept a bib and form a water tight seal around the bib.

2. The AWG apparatus of claim 1, where the valve end further includes threads adapted to accept threads of the bib in order to form the water tight seal.

3. The AWG apparatus of claim 1, where the valve end has at least one screw hole that is able to accept a screw that passes through the faucet to secure the faucet to the valve end of the AWG.

4. The AWG apparatus of claim 1, further including an insulated area between the bib and the body.

5. The AWG apparatus of claim 4, where the insulation is an open cell foam.

6. The AWG apparatus of claim 4, where the insulation is a water dissolvable insulation material.

7. A method for guarding against water leaks, comprising:
affixing a body with a faucet end and a valve end to a dwelling, where the valve end has at least one water hole; and
securing a bib within the body, where a portion of the faucet end is adapted to accept a faucet and the body is able to accept the bib and form a water tight seal around the bib.

8. The method of claim 7, including affixing to the faucet end the faucet associated with the bib.

9. The method of claim 8, where affixing to the faucet end further includes screwing a screw through the faucet into the faucet end.

10. The method of claim 7, where securing the bib further includes screwing the bib into a threaded portion of the valve end.

11. The method of claim 7, further including inserting insulation between the bib and the body.

12. The method of claim 11, where the insulation is an open cell foam.

13. The method of claim 11, where the insulation is a water dissolvable insulation material.

14. The method of claim 7, where securing further includes securing the faucet end of the body to the dwelling with an adhesive.
